(19) United States
(12) Patent Application Publication
(10) Pub. No.: US 2003/0098982 A1
(43) Pub. Date: May 29, 2003

(54) Truncated series-based resonant cavity interferometer

(75) Inventors: Robert R. McLeod, Morgan Hill, CA (US); Gang Lei, San Jose, CA (US); Long Yang, Union City, CA (US); Kuochou Tai, Fremont, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 09/993,550

(22) Filed: Nov. 28, 2001

(51) Int. Cl. G01B 9/02

(52) U.S. Cl. 356/519

(57) ABSTRACT

A truncated series-based cavity interferometer contains a multi-reflection cavity upon which an input light beam is directed at an acute angle, to produce a spatially spread series of multiple order beams through which the transfer function (e.g., a generally square pass/stop profile) of the interferometer is defined. Because the input beam is incident upon the cavity at an acute angle, it is non counter-propagating with respect to the reflected beam, so that no circulator is required for beam separation. The intensity profile of the energy contained in the composite set of spatially separated multiple order beams comprises a spatially separated decaying series of reflections, that are intercepted by independently positionable spatial filter elements.

### FIELD OF THE INVENTION

The present invention relates in general to optical signal processing systems and components therefor, and is particularly directed to a new and improved interferometer having a truncated series-based resonant cavity implementation, that obviates the need for a circulator to separate counter-propagating input and reflected beams, and provides improved performance over a conventional infinite series-based resonant cavity architecture.

### BACKGROUND OF THE INVENTION

A number of optical signal processing applications, such as but not limited to wavelength division multiplexers (WDMs), use interferometers to discriminate among optical frequency components of an input light beam. In its most basic form, the interferometer may be configured to split or divide the beam into two paths of unequal lengths, and then recombine the differential path length beams into a composite output beam, whose intensity is a sinusoidal function of the relative path difference between the two beams. For high contrast operation in which the minimum of the sinusoidal transmission function is nearly zero, the ratio of the power in the two paths should be very nearly unity.

Unfortunately, the sinusoidal shape of the interferometer's transmission profile is not necessarily optimal in all applications. In a WDM of the type used for telecommunication applications, for example, a square-wave profile having essentially relatively sharply defined (e.g., ‘squared-off’ or ‘flat’) pass- and stop-bands is usually preferred. Because a periodic waveform can be represented mathematically by a Fourier series, it is possible to implement an interferometer having a square-wave transmission profile, by modifying the basic two-path interferometer architecture so as to increase the number of differential length optical paths, and thereby generate a relatively large number of harmonic frequencies or side tones which, when recombined, produce a more sharply defined (e.g., ‘square-wave-like’) profile.

For this purpose, two types or classes of multi-path interferometers have been proposed: 1—a finite series Solc filter; and 2—an ‘infinite series’ resonant cavity interferometer. In the Solc filter, a series of two-path interferometers are coupled in cascade to produce a ‘finite’ series of paths. As the number of stages of the Solc filter is increased, the number of harmonic terms is also increased, so that its composite transmission profile can be made more ‘square’-like. In the ‘infinite’ series resonant cavity interferometer, a resonant cavity is installed in one or more interferometer paths, causing the number of effective optical paths to be increased very substantially (ideally effectively infinite). This infinite series approach produces a highly square-like band pass filter characteristic, and provides improved performance over a finite series device, such as the Solc filter.

Non-limiting examples of an ‘infinite series’ resonant interferometer include the Michelson Gires Tournois resonant interferometer diagrammatically illustrated in FIG. 1, and described in an article by B. Dingel et al, entitled: “Properties of a Novel Non-cascaded Type, Easy-to-Design, Ripple-Free Optical Bandpass Filter,” Journal of Lightwave Technology, Vol. 17, No. 8, August, 1999, pp. 1461-1469, and the multi-cavity Fabry-Perot interferometer shown in FIG. 2, and described in an article by H. van de Stadt et al, entitled: “Multi-mirror Fabry-Perot Interferometers,” Journal of the Optical Society of America, Vol. 2, No. 8., August 1985, pp. 1363-1370.

In the multi-path ‘infinite series’ based architecture of FIG. 1, an input light beam I (such as a laser-sourced coherent light beam supplied by an input optical fiber) is coupled into and through a circulator 10 (which is required to extract the reflected beam, as will be described) along a first, input beam path or arm 11. In addition to the circulator, the first beam path 11 contains a collimator 12, which focusses the beam through a beam-splitter 13 onto a resonant cavity 14 formed of a partially reflective mirror 15 and an adjacent fully reflective mirror 16. The purpose of the resonant cavity 15 is to cause repeated internal reflections of the input light beam along differential transmission paths, and thereby produce an infinite series of beam components in a return direction out of the cavity 15 towards the beam-splitter 13.

Within the beam-splitter 13, a portion of this returned infinite series of higher order beam components passes through the partially reflective interface 17 along path 11 and a portion is reflected along a second beam path 23. In addition, a portion of the collimated input beam I is reflected by the beam splitter's partially reflective interface 17 onto a second reflective mirror 21 installed in the second beam path 23. Part of the incident beam reflected off the mirror 21 and returned through the partially reflective interface 17 is coincident and combined with the resonant cavity-generated infinite series of multiply reflected beams to produce a Fourier series of beam components traveling along transmission path 23. The resultant or composite optical energy in the transmission path beam 23 is coupled by way of a collimator 25 into an output channel, such as a transmit (T) optical waveguide (fiber) 27.

A second portion of the input beam returned by the mirror 21 is reflected by the beam splitter's partially reflective interface 17 back along the first beam path 11, so that it also coincident and combines with the infinite series of beams traveling along path 11. Because the input beam and the composite optical energy in the Fourier series of beams returned along path 11 are mutually counter-propagating, separation of the reflected beam R from the incident beam I requires the use of circulator 10 (a very costly component). The circulator-separated reflected beam is then extracted from an output port 18 of the circulator 10 and may be coupled to an output optical waveguide (e.g., optical fiber) 28.

In the Michelson Gires Tournois interferometer of FIG. 1, the Fourier series of mutually coincident input and harmonic beam components in each of the transmit and reflect arms as coupled into the respective transmit and reflect optical waveguides has a bandpass profile corresponding to the intensity vs. frequency characteristic of FIG. 3. As shown therein, the interferometer's bandpass profile 30 has a substantially ‘flat’ (on the order of 0 dB attenuation) region 31 over a prescribed portion of the band (e.g., between normalized frequency values on the order of −0.4 to +0.4) and relatively sharply reduced intensity (on the order of −32 dB or greater) sidelobes 32 and 33 in the vicinity of normalized frequency values of −1.0 and +1.0.

Also shown in FIG. 3 are well defined or ‘vertical roll-off’ (generally rectangularly shaped) spectral segments 41, 42 and 43 associated with desired information transmission bands of a typical telecommunication specification. Since the spectral width of the relatively narrow transmission passband segment 41 falls well within the substantially ‘flat’ 0 dB attenuation region 31 of the interferometer's bandpass profile, while those of segments 42 and 43 are reasonably well spaced apart from the region 31 (and generally overlie respective attenuated sidelobe regions 32 and 33), it can be seen that the interferometer architecture of FIG. 1 is capable of producing the sought after ‘generally square’ on/off filter function.

In the multi-cavity Fabry-Perot architecture of FIG. 2 (which is also capable of providing a bandpass characteristic substantially as shown in FIG. 3), the beam splitter and multiple reflecting mirror components of the resonant cavity, beam-splitting structure of FIG. 1 are replaced by a multiple Fabry-Perot transmission block 50. This component contains a series of partially reflective surfaces (such as the four reflective surfaces shown at 51, 52, 53 and 54) installed in input beam path 11 between the input collimator 12 and the output collimator 25. As in the infinite series architecture of FIG. 1, since the input beam and the infinite series of reflections produced by block 50 are mutually counter-propagating, separation of the reflected beam R from the incident beam I again requires the use of a very costly circulator 10.

Now although the performance of an infinite-series based resonant cavity architecture, such as those shown in FIGS. 1 and 2, offers an improvement over a finite series device, such as a cascaded Solc filter, the intended behavior of an infinite-series resonant cavity interferometer is premised upon the assumption that the propagating light is a perfect plane wave having normal incidence upon the resonant cavity's reflective surfaces. In reality, however, the beam components are spatially localized, with increased numbers of beam reflections producing increased amounts of divergence and loss. In addition, because the normal incidence requirements of these architectures cause the light paths of the input beams and the cavity-sourced harmonics to be mutually counter-propagating, it is necessary to install a circulator to separate the input beam from the reflected beam, thereby increasing loss and complexity, and adding substantial cost.

### SUMMARY OF THE INVENTION

Pursuant to the invention, drawbacks of conventional infinite-series-based interferometer architectures, such as those of FIGS. 1 and 2, described above, are effectively obviated by a truncated series-based cavity interferometer architecture. As will be described, like a conventional resonant cavity interferometer, the truncated series-based architecture of the invention employs a multi-reflection cavity that produces multiple reflections of the input beam and generates a series of multiple order beams through which the transfer function (e.g., a generally square pass/stop profile) of the interferometer is defined. However, rather than direct the input beam along a path having normal incidence to the reflection surfaces of the cavity, and thereby cause all of the beam components to be effectively mutually coincident, the input beam is obliquely incident upon the cavity at an acute angle that is non-normal to the planes of the reflective surfaces of the cavity.

The effect of this non-normal incidence is two-fold. First, it prevents the input and reflected beams from being counter-propagating, and obviates the need for a circulator. Secondly, the multiple reflections produced by the resonant cavity, rather than being mutually coincident with each other as well as with the input beam, are produced as a spatially spread ‘quasi-infinite’ series of multi-order beam components of successively decaying or decreasing intensity, from which a selectively tailored (e.g., generally square) transmission profile can be realized. This enables the intensity profile of the transmitted and reflected beams to be readily controlled by spatially filtering or ‘truncating’ the energy contained in the set of spatially separated beam components produced by the multi-reflection cavity.

Pursuant to the invention, each of the transmitted and reflected composite set of spatially spread beam components is intercepted by ‘independently positionable’ spatial filter elements. The spatial filter elements themselves may comprise single-mode optical fibers attached to collimating lenses to form approximately Gaussian filters. Each filter has a pure amplitude mask (i.e., it introduces loss) in any plane located at the minimum waist of the Gaussian beam.

The ability to independently spatially filter selected ones of the spread apart multi-order beam components produced by the resonant cavity means that the invention is capable of changing the transmission profile within a prescribed family of functions for either of the transmitted and reflected beams. Thus, for the case of bandstop/bandpass filter of the type used for telecommunication applications, the main lobe of the bandpass characteristic produced by the truncated series interferometer architecture of the invention may have a substantially ‘flat’ pass region, the spectral width of which readily accommodates the narrow passband segment of an information transmission band of a telecommunication specification. This main lobe rolls off to very severely attenuated sidelobe regions that are highly suppressed relative to the stopband regions of the transmission profile produced by a conventional infinite series-based interferometer, described above.

Because the spatial filter elements are individually and selectively positionable with respect to the reflected composite beam sets within the reflection and transmission paths, they allow prescribed or selected ‘truncated’ portions of each quasi-infinite series of beams to be coupled therethrough to its associated output (R/T) channel. This ability of the invention to individually tailor the spatial filter characteristics of each of the reflection and transmission paths is especially beneficial when the interferometer is used as a three-port device to multiplex or demultiplex periodically interleaved WDM channels. Moreover, the adjustability of the spatial filters for manipulating loss in each output path independently allows the contrast of the truncated-series interferometer of the invention to be made higher than that of the conventional infinite-series devices. This independent adjustment capability can be also used to compensate for variations in fabrication tolerances, by balancing loss and other performance parameters, such as high contrast.

### BRIEF DESCRIPTION OF THE DRAWINGS

FIG. 1 diagrammatically illustrates a conventional Michelson Gires Tournois ‘infinite series’ interferometer;

FIG. 2 diagrammatically illustrates a conventional multi-cavity Fabry-Perot infinite-series interferometer;

FIG. 3 shows the bandpass profile of a conventional infinite series interferometer;

FIG. 4 diagrammatically illustrates a modification of the Michelson Gires Tournois interferometer of FIG. 1 to realize a ‘truncated series’ interferometer-based spatial filter in accordance with a first embodiment of the invention;

FIG. 5 is an intensity profile for a portion of the energy contained in the composite set of spatially separated multi-order beam components produced by the ‘truncated series’ interferometer-based spatial filter of the invention;

FIG. 6 diagrammatically illustrates the manner in which the multi-cavity Fabry-Perot architecture of FIG. 2 may be modified to realize a ‘truncated series’ interferometer-based spatial filter, in accordance with a second embodiment of the present invention; and

FIG. 7 is an intensity vs. frequency characteristic produced by the truncated series-based interferometer structure of FIGS. 4 and 6.

### DETAILED DESCRIPTION

Attention is now directed to FIG. 4, which diagrammatically illustrates a modification of the infinite series Michelson Gires Tournois type interferometer shown in FIG. 1, in accordance with a first embodiment of a ‘truncated series’ interferometer-based spatial filter of the present invention. As will be understood from the description to follow, the ‘truncated’ series-based interferometer architecture of the invention employs a multi-reflection cavity, which is configured to produce what may be termed a ‘quasi-infinite’ series of beam harmonic components, that do not counter-propagate along the same path as the input beam, so as to obviate having to use a circulator to separate the output beams from the input beam.

For this purpose, similar to the multi-path ‘infinite series’ based architecture of FIG. 1, an incident light beam I of an input arm or path 61 is supplied over an optical input channel, such as by way of an input optical waveguide or fiber 63, to a collimator 65. However, unlike the input path of the structure of FIG. 1, which causes the input beam path to have normal incidence to the reflecting components of its multi-reflection resonant cavity 25, the input path 61 of the collimated input light beam produced by collimator 65 is directed through a beam-splitter 71 at an acute (non-orthogonal) angle of incidence upon each of a pair of mutually parallel, cavity-defining mirrors 81 and 83 (such as plane mirrors) of a multi-reflecting cavity 80. As a non-limiting example, for a transmission vs. reflected channel spacing of 100 GHz, the angle of incidence of the input may be on the order of 3° relative to a normal to the plane surfaces of mirrors 81 and 83. In addition to passing through the beam splitter so as to be incident upon cavity 80, a portion of the collimated input beam I is reflected by the beam splitter onto a reflective mirror 85 installed in a transmit beam path 77.

As in the resonant cavity of the Michelson Gires Tournois structure of FIG. 1, plane mirror 81 may comprise a partially reflective input/output mirror, while plane mirror 83 may comprise a fully (100%) reflective mirror. However, due to the non-normal incidence of the input beam path 61 upon the cavity mirrors 81 and 83, the multiple reflections produced by the mirrors are a plurality of non-coincident and spatially separated harmonic beam components 91, 92, . . . , 9N, that are tilted or directed away (e.g., at 3° relative to the normal) from the cavity incidence angle (e.g. 3°) of the input beam path 61. If mirrors 81 and 83 were parallel ‘infinite plane’ mirrors, they would produce an infinite number of non-coincident, successively decreasing intensity reflections along sequential paths at acute angles relative to the mirror surfaces. However, Due to the physical constraints of the mirror cavity 80, a very large (quasi-infinite) series of spatially spread apart reflections is produced.

This quasi-infinite series of spatially separated harmonic components 91-9N produced by the multi-reflection cavity 80 reenters the beam-splitter 71 to be incident upon an internal partially reflective surface 73. Part of this spaced apart harmonic beam set passes through the reflective surface 73 and exits the beam splitter along a reflected beam path 75. Another portion is reflected by the beam splitter's reflective surface 73 and exits the beam splitter along the transmitted beam path 77. One portion of the incident beam reflected off the mirror 85 passes through the beam splitter's partially reflective internal interface 73 of the beam splitter 71 and combined with the series of beams 91-9N to realize a finite Fourier series of beam components traveling along transmission path 77. Another portion is reflected by the beam splitter's interface 73 along the reflection path as part of the set of finite beams traveling along the reflection beam path 75. As a result, each of the reflection and transmission beam paths is a composite of energy of the incident optical beam I, as well as energy in the finite series of harmonic beam components 91-9N produced by the cavity 80.

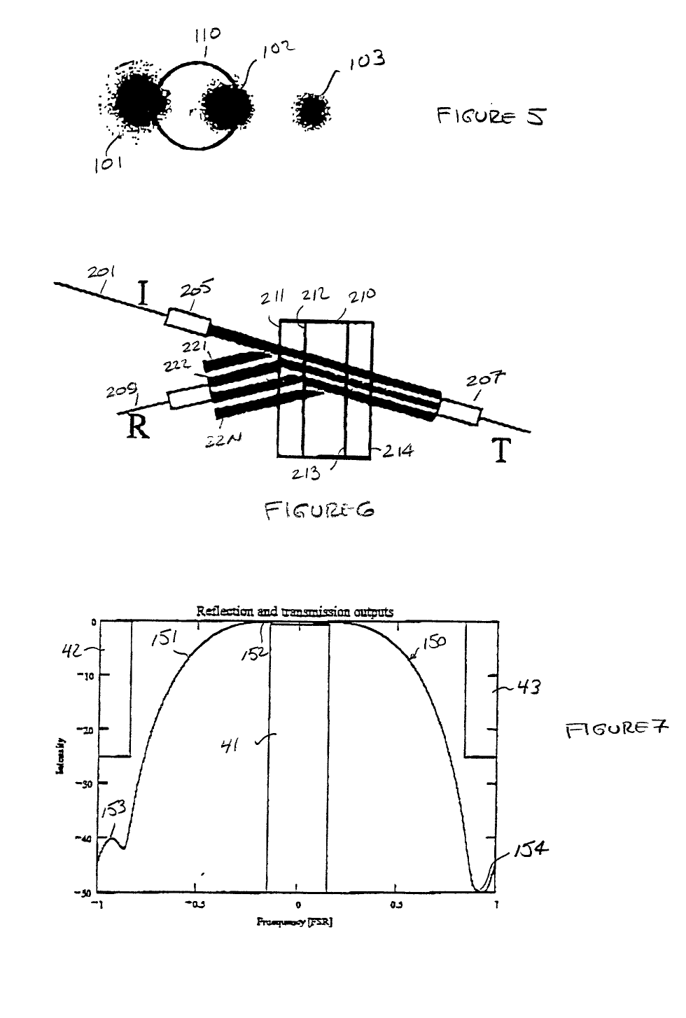

FIG. 5 is an intensity profile for a portion of the energy contained in the composite set of spatially separated beam components (spacings among which are exaggerated for clarity) produced by cavity 80 and traveling along the reflection and transmission paths 75 and 77, respectively. As shown therein, the composite reflected beam set comprises a spatially separated decaying series of reflections, three of which are shown at 101, 102 and 103. Superimposed on the beam set is a circle 110 having an area which represents the light-collecting apertures of respective spatial filter elements 121 and 123.

As a non-limiting example, each of the spatial filter elements may comprise a single-mode optical fiber attached to a collimating lens to form an approximately Gaussian filter. Such a filter has a pure amplitude mask in any plane located at the minimum waist of the Gaussian beam. For purposes of the present invention, the mask has an amplitude component, i.e., it introduces loss. These spatial filter elements are individually and selectively positionable with respect to the spatially successive multi-order beam sets within the reflection and transmission paths, so as to allow prescribed portions of each quasi-infinite series of beam components to be coupled to its associated output (R/T) channel. For this purpose, each spatial filter (e.g., lens-fiber pair) may be independently transversely displaced relative to the direction of the path of its associated multiple reflection beam set, in order to couple a selected fraction of, or ‘truncate’, the individual terms of the quasi-infinite series of reflected beam terms through the filter's beam-coupling aperture.

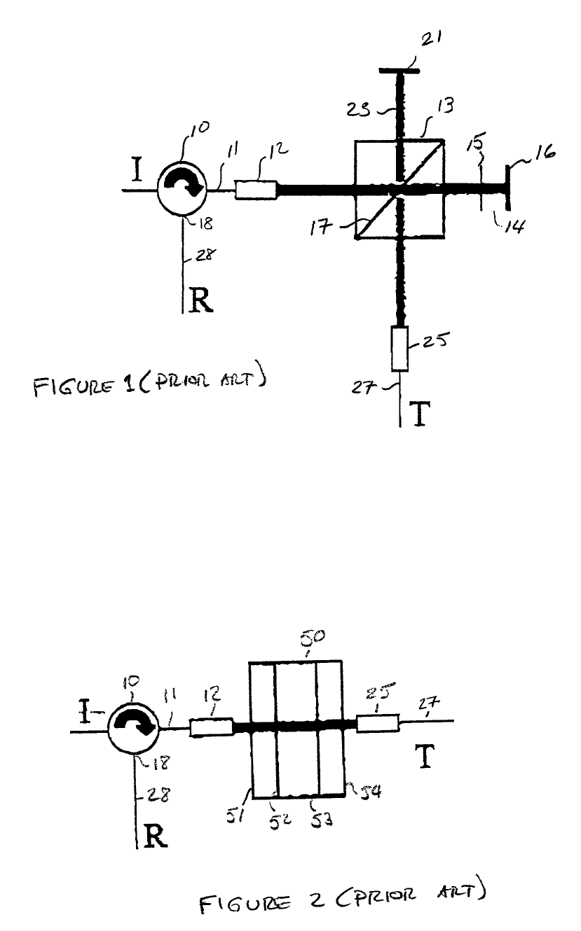

FIG. 6 diagrammatically illustrates the manner in which the multi-cavity Fabry-Perot architecture of FIG. 2 may be modified to realize a ‘truncated series’ interferometer-based spatial filter, in accordance with a second embodiment of the present invention. As shown therein, an input light beam I of an input path 201 supplied over an optical input channel, such as by way of an input optical waveguide or fiber 203, is coupled to an input beam collimator 205. As in the first embodiment, to obviate the need for a circulator and produce a spatial series of decaying intensity beam terms, the input path 201 of the collimated input light beam is directed upon a multiple Fabry-Perot transmission block 210 at an acute angle (e.g., 3° relative to normal incidence), so that the reflected beam terms will be non-coincident with the incident beam.

Like the block 50 of FIG. 2, the multiple Fabry-Perot transmission block 210 contains a series of partially reflective surfaces (four of which are shown at 211, 212, 213 and 214) installed in the incident beam's input arm 201 between the input collimator 205 and a transmission output port 207. Due to the acute angle of incidence of the input beam I on the multiple Fabry-Perot transmission block 210, the respective partially reflective surfaces of block 210 produce a plurality of non-coincident and spatially separated harmonic reflected beam components 221, 222, . . . , 22N, that are tilted or directed away from the incidence angle of the input beam path 201. Again, due to the physical constraints of the block 210, a finite number or series of spatially adjacent reflections is produced. A first portion of this finite series of spatially separated beam components 221-22N is reflected along a reflected beam (R) path 209 to a reflected beam output port 225.

A second portion of the finite series of spatially separated beam components 221-22N passes through the block 210 along the direction of the input beam path 201 to the transmission (T) output port 207. As in the first embodiment, each of the reflection and transmission beam paths includes energy of the incident optical beam I as well as that in the finite series of harmonic beam components 221-22N. Also, as in the first embodiment, each output port has a respective spatial filter element, such as a single-mode optical fiber attached to a collimating lens, that is independently transversely displaceable relative to the direction of the path of its associated multiple reflection beam set, and thereby operative couple a selected fraction of, or ‘truncate’, the individual terms of the quasi-infinite series of reflected beam terms through the light-coupling aperture of the filter.

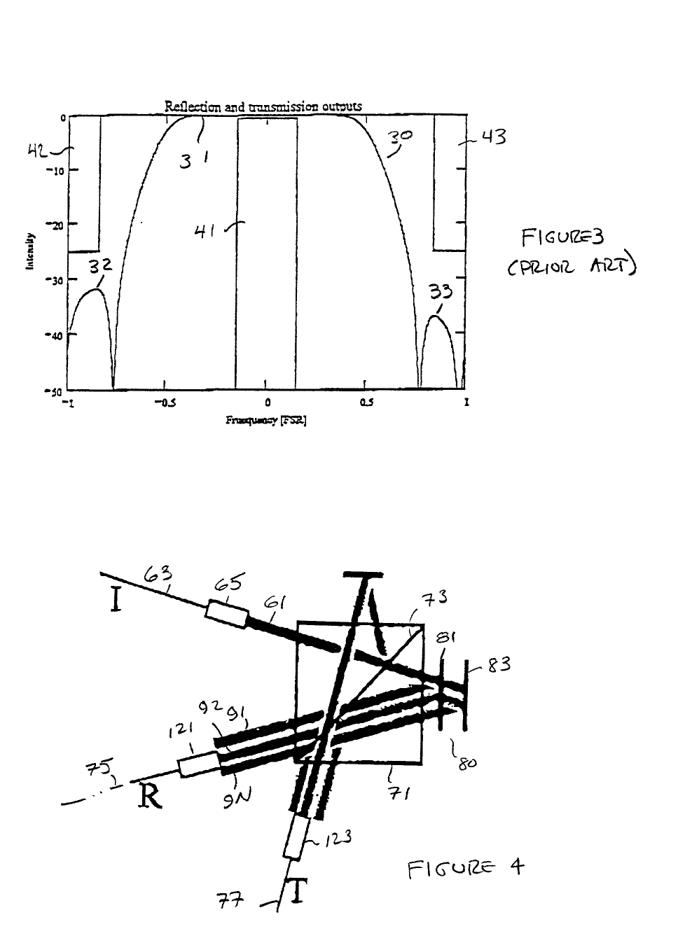

FIG. 7 is an intensity vs. frequency characteristic produced by a truncated series structure of the type shown in FIGS. 4 and 6, and whose spatial filters are configured and selectively placed in the spread beam sets to produce a ‘squared-off’ bandpass profile 150 is similar to that of FIG. 3. By squared-off is meant that its main lobe 151 has a substantially ‘flat’ (on the order of 0 dB attenuation) region 152, the spectral width of which, although narrower than that of FIG. 3, is sufficient to accommodate the narrow passband segment 131 of an information transmission band of a telecommunication specification. On the other hand, the main lobe 151 of the bandpass profile 150 of FIG. 7 rolls off to very severely attenuated sidelobe regions 153 and 154, that are substantially suppressed (greater than 40 dB down) relative to the regions 32 and 33 of the infinite series-based interferometer profile of FIG. 3.

Also shown in FIG. 7 are generally rectangularly shaped spectral segments 132 and 133 associated with a pair of transmission bands that are spaced apart from band 131, and generally aligned with the sharply attenuated sidelobe regions 153 and 154 of the bandpass profile. As these sidelobe regions are extremely attenuated and lie well below the floor of their associated spectral segments, it will be appreciated that the on/off performance of the generally ‘square’ spatial filter function produced by the truncated interferometer architecture of FIGS. 4 and 6 enjoys a substantial improvement over that of a conventional infinite series device.

As pointed out above, the ability of the invention to individually tailor the spatial filter characteristics of each of the reflection and transmission paths is particularly beneficial, when the interferometer is used as a three-port device to multiplex or demultiplex periodically interleaved WDM channels. The spatial filters may also be adjusted to manipulate the loss in each output path independently, whereby the contrast of the truncated-series interferometer of the invention can be made higher than that of an analogous infinite-series device, such as those shown in FIGS. 1 and 2. This independent adjustment feature can also be employed to compensate for variations in fabrication tolerances, by balancing loss and other performance parameters, such as high contrast. The performance of an infinite series device, on the other hand, is determined only the spacings and reflectivities of the various mirrors, and no adjustment of performance is possible once the mirrors are assembled.

While we have shown and described several embodiments in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

What is claimed:

1. An interferometer architecture comprising:
an input port to which an input optical beam is coupled;
a transmission output port from which a first output optical beam is coupled;
a reflection output port from which a second output optical beam is coupled; and
a multi-reflection cavity upon which said input beam is incident so as to be non counter-propagating with either of said first and second output optical beams, and being operative to cause multiple reflections therein of said input beam and produce therefrom multiple order beams that define the composition of said first and second output optical beams.

2. The interferometer architecture according to claim 1, wherein said multi-reflection cavity comprises a plurality of parallel planar reflective surfaces, and wherein said input beam is incident upon said multi-reflection cavity in a direction that is non-orthogonal to said plurality of planar surfaces thereof.

3. The interferometer architecture according to claim 1, further including first and second spatial filter elements respectively coupled in optical transport paths of said first and second output optical beams.

4. The interferometer architecture according to claim 3, wherein said first and second spatial filter elements are independently and selectively positionable relative to optical transport paths of said first and second output optical beams, respectively, and are configured to allow prescribed truncated portions of said multiple order beams thereof to be coupled therethrough to said transmission and reflection output ports.

5. The interferometer architecture according to claim 1, wherein said multiple order beams produced by said multiple reflections of said input beam in said multi-reflection cavity comprise a spatially spread series of multiple order beams.

6. The interferometer architecture according to claim 1, wherein said multi-reflection cavity comprises a resonant cavity for a Michelson Gires Tournois interferometer.

7. The interferometer architecture according to claim 1, wherein said multi-reflection cavity comprises a resonant cavity for a Fabry-Perot interferometer.

8. A method of spatially filtering an input optical beam to produce first and second optical output beams, comprising the steps of:
(a) coupling said input optical beam to a multi-reflection cavity so as to be non counter-propagating with either of said first and second optical beams, said multi-reflection cavity causing multiple reflections therein of said input beam and producing therefrom multiple order beams that define the composition of said first and second output optical beams; and
(b) spatially filtering said first and second output optical beams with first and second spatial filter elements, respectively, that are independently and selectively positionable relative to optical transport paths of said first and second output optical beams, so as to allow prescribed truncated portions of said multiple order beams of said first and second output optical beams to be coupled therethrough.

9. The method according to claim 8, wherein said multi-reflection cavity comprises a plurality of parallel planar reflective surfaces, and wherein step (a) comprises directing said input beam upon said multi-reflection cavity in a direction that is non-orthogonal to said plurality of planar surfaces thereof.

10. The method according to claim 8, wherein said multiple order beams produced by said multiple reflections of said input beam in said multi-reflection cavity comprise a spatially spread series of multiple order beams.

11. The method according to claim 8, wherein step (b) comprises independently and selectively positioning said first and second spatial filter elements in said optical transport paths of said first and second output optical beams, so as to spatially define said prescribed truncated portions of said multiple order beams of said first and second output optical beams in accordance with a prescribed passband vs. stopband transmission profile therefor.

12. The method according to claim 8, wherein said multi-reflection cavity comprises a resonant cavity for a Michelson Gires Tournois interferometer.

13. The method according to claim 8, wherein said multi-reflection cavity comprises a resonant cavity for a Fabry-Perot interferometer.

14. A method of spatially filtering an input optical beam to produce first and second optical output beams which conform with a prescribed passband vs. stopband transmission profile comprising the steps of:
(a) coupling said input optical beam to a multi-reflection cavity so as to be non counter-propagating with each of said first and second optical beams, said multi-reflection cavity causing multiple reflections therein of said input beam and producing therefrom spatially spread apart multiple order beams that define the composition of said first and second output optical beams; and
(b) coupling said first and second output optical beams through first and second adjustably positionable spatial filter elements, respectively; and
(c) independently and selectively adjusting said first and second spatial filter elements relative to optical transport paths of said first and second output optical beams, and thereby truncate prescribed portions of said spatially spread apart multiple order beams of said first and second output optical beams in accordance with said prescribed passband vs. stopband transmission profile.

15. The method according to claim 14, wherein said multi-reflection cavity comprises a plurality of parallel planar reflective surfaces, and wherein step (a) comprises directing said input beam at an acute angle upon said multi-reflection cavity in a direction that is non-orthogonal to said plurality of planar surfaces thereof.

16. The method according to claim 14, wherein said multiple order beams produced by said multiple reflections of said input beam in said multi-reflection cavity comprise a spatially spread series of multiple order beams.

17. The method according to claim 14, wherein said multi-reflection cavity comprises a resonant cavity for a Michelson Gires Tournois interferometer.

18. The method according to claim 14, wherein said multi-reflection cavity comprises a resonant cavity for a Fabry-Perot interferometer.
